(19) United States
(12) Patent Application Publication
(10) Pub. No.: US 2022/0123385 A1
(43) Pub. Date: Apr. 21, 2022

(54) APPARATUS AND METHOD FOR AN INTEGRATED CELL SEPARATOR

(71) Applicant: Vertical Partners West, LLC, Rathdrum, ID (US)

(72) Inventors: Antonio Reis, Reisterstown, MD (US); Jason Koneval, Coeur D' Alene, ID (US)

(73) Assignee: Vertical Partners West, LLC, Rathdrum, ID (US)

(21) Appl. No.: 17/506,228

(22) Filed: Oct. 20, 2021

Related U.S. Application Data
(60) Provisional application No. 63/093,885, filed on Oct. 20, 2020.

(51) Int. Cl. H01M 10/658; H01M 10/655; H01M 10/647; H01M 10/6552

(52) U.S. Cl. CPC H01M 10/658; H01M 10/655; H01M 10/0525; H01M 10/6552; H01M 10/647

(57) ABSTRACT

An integrated cell separator adapted for use with one or more battery cells. The separator includes a thermal isolation/flame-resistant layer and a compliant layer. The compliant layer is adjacent to the thermal/isolation/flame resistant layer. The thermal isolation/flame-resistant layer and the compliant layer are adhered to each other, the compliant layer is adapted to contact the one or more battery cells, and the separator is adapted to provide thermal runaway isolation of the one or more battery cells. A method for separating one or more battery cells.

### CROSS-REFERENCES TO RELATED APPLICATIONS/PATENTS

This application relates back to and claims the benefit of priority from U.S. Provisional application for Patent Ser. No. 63/093,885 titled “Integrated Cell Separator” and filed on Oct. 20, 2020.

### FIELD OF THE INVENTION

The present invention relates generally to apparatuses and methods for battery cells, and particularly to apparatuses and methods for an integrated battery cell separator.

### BACKGROUND AND DESCRIPTION OF THE PRIOR ART

It is known to use apparatuses and methods to separate one or more battery cells from each other and their ambient environment. Conventional apparatuses and methods, however, suffer from one or more disadvantages. For example, conventional cell separators and methods do not sufficiently reduce fire propagation or fire temperature. Conventional cell separators and methods also do not sufficiently maintain heat compartmentalization, isolate thermal runaway at a cell level, or isolate thermal runaway at a module level. Further, conventional cell separators and methods do not sufficiently permit gases to flow through them, permit pressure dissipation, permit heat removal from battery cells to their environment, or permit heat distribution in a battery pack. Still further, conventional cell separators and methods do not sufficiently maintain or improve battery cycle life, reliability, or functionality. In addition, conventional cell separators and methods are undesirably expensive and non-integrated. Conventional cell separators and methods also do not apply uniform pressure to the surface of battery cell electrodes, provide tolerance to vibration, or maintain cell impedance over time. Further, conventional cell separators do not provide battery power capability without degradation or electrical isolation of battery cells.

It would be desirable, therefore, if an apparatus and method for an integrated cell separator could be provided that would sufficiently reduce fire propagation and fire temperature. It would also be desirable if such an apparatus and method for an integrated cell separator could be provided that would sufficiently maintain heat compartmentalization, isolate thermal runaway at a cell level, and isolate thermal runaway at a module level. It would be further desirable if such an apparatus and method for an integrated cell separator could be provided that would sufficiently permit gases to flow through it, permit pressure dissipation, permit heat removal from battery cells to their environment, and permit heat distribution in a battery pack. It would be still further desirable if such an apparatus and method for an integrated cell separator could be provided that would sufficiently maintain and improve battery cycle life, reliability, and functionality. In addition, it would be desirable if such an apparatus and method for an integrated cell separator could be provided that would not be undesirably expensive or non-integrated. It would also be desirable if such an apparatus and method for an integrated cell separator could be provided that would apply uniform pressure to the surface of battery cell electrodes, provide tolerance to vibration, and maintain cell impedance over time. Further, it would be desirable if such an apparatus and method for an integrated cell separator could be provided that would provide battery power capability without degradation and electrical isolation of battery cells.

### ADVANTAGES OF THE PREFERRED EMBODIMENTS OF THE INVENTION

Accordingly, it is an advantage of the preferred embodiments of the invention claimed herein to provide an apparatus and method for an integrated cell separator that reduces fire propagation and fire temperature. It is also an advantage of the preferred embodiments of the invention claimed herein to provide an apparatus and method for an integrated cell separator that maintains heat compartmentalization, isolates thermal runaway at a cell level, and isolates thermal runaway at a module level. It is another advantage of the preferred embodiments of the invention claimed herein to provide an apparatus and method for an integrated cell separator that permits gases to flow through it, permits pressure dissipation, permits heat removal from battery cells to their environment, and permits heat distribution in a battery pack. It is still another advantage of the preferred embodiments of the invention claimed herein to provide an apparatus and method for an integrated cell separator that maintains and improves battery cycle life, reliability, and functionality. It is yet another advantage of the preferred embodiments of the invention claimed herein to provide an apparatus and method for an integrated cell separator that is not undesirably expensive or non-integrated. In addition, it is an advantage of the preferred embodiments of the invention claimed herein to provide an apparatus and method for an integrated cell separator that applies uniform pressure to the surface of battery cell electrodes, provides tolerance to vibration, and maintains cell impedance over time. It is an additional advantage of the preferred embodiments of the invention claimed herein to provide an apparatus and method for an integrated cell separator that provides battery power capability without degradation and electrical isolation of battery cells.

Additional advantages of the preferred embodiments of the invention will become apparent from an examination of the drawings and the ensuing description.

### EXPLANATION OF THE TECHNICAL TERMS

The use of the terms “a,” “an,” “the,” and similar terms in the context of describing the invention are to be construed to cover both the singular and the plural, unless otherwise indicated herein or clearly contradicted by context. The terms “comprising” “having,” “including,” and “containing” are to be construed as open-ended terms (i.e., meaning “including, but not limited to,”) unless otherwise noted. The terms “substantially,” “generally,” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic. All methods described herein can be performed in any suitable order unless otherwise specified herein or clearly indicated by context.

Terms concerning attachments, coupling and the like, such as “attached,” “connected,” and “interconnected,” refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as,” “preferred,” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity. Several terms are specifically defined herein. These terms are to be given their broadest reasonable construction consistent with such definitions, as follows:

As used herein, the term “battery” means a device comprising one or more cells, in which chemical energy is converted into electricity.

As used herein, the term “cell” means an electrochemical device, composed of positive and negative plates and electrolyte, which is capable of storing electrical energy. It is the basic “building block” of a battery.

As used herein, the term “cycle life” means, for rechargeable batteries, the total number of charge/discharge cycles the cell can sustain before its capacity is significantly reduced.

As used herein, the term “electrical isolation” means the process of not allowing the flow of electricity from one point to another.

As used herein, the term “energy density” means the ratio of cell energy to weight or volume (watt-hours per liter (Wh/L), or watt-hours per kilogram (Wh/kg))

As used herein, the term “module” means a battery assembly comprised of affixing a number of individual cells together into a modular package. This subassembly is usually combined with other modules to form a larger system or “pack”

As used herein, the term “pack” means the final shape of the battery system comprised of multiple modules; for example 8 cells per module, 4 modules per pack for a completed system.

As used herein, the term “pouch” means a battery cell construction type that normally contains an anode, separator, cathode, a current collector and tabs housed in a foil pouch.

As used herein, the term “thermal isolation” means the process of blocking or reducing the transmission of heat from one cell to another within a module or pack.

As used herein, the term “thermal mitigation” means the process of limiting the potential damaging effects of heat within a battery module or pack.

As used herein, the term “thermal runaway” means a critical condition arising during either charging or discharge in which the battery creates an amount of heat that exceeds the ability of the battery to dissipate the heat leading to a non-reversible chemical instability reaction that normally leads to pressure building, swelling, and ultimately can lead to fire.

### SUMMARY OF THE INVENTION

The apparatus of the invention comprises an integrated cell separator adapted for use with one or more battery cells. The preferred integrated cell separator comprises a thermal isolation/flame-resistant layer and a compliant layer. The preferred compliant layer is adjacent to the thermal/isolation/flame resistant layer. Preferably, the thermal isolation/flame-resistant layer and the compliant layer are adhered to each other to produce the integrated cell separator, the compliant layer is adapted to contact the one or more battery cells, and the separator is adapted to provide thermal runaway isolation of the one or more battery cells.

The method of the invention comprises a method for separating one or more battery cells. The preferred method comprises providing an integrated cell separator. The preferred integrated cell separator comprises a thermal isolation/flame-resistant layer and a compliant layer. The preferred compliant layer is adjacent to the thermal/isolation/flame resistant layer. Preferably, the thermal isolation/flame-resistant layer and the compliant layer are adhered to each other to produce the integrated cell separator, the compliant layer is adapted to contact the one or more battery cells, and the separator is adapted to provide thermal runaway isolation of the one or more battery cells. The preferred method further comprises separating one or more battery cells using the integrated cell separator.

### BRIEF DESCRIPTION OF THE DRAWINGS

The presently preferred embodiments of the invention are illustrated in the accompanying drawings, in which like reference numerals represent like parts throughout, and in which:

FIG. 1 is a front perspective view of the preferred embodiment of the integrated cell separators in accordance with the present invention shown with a plurality of prismatic cells.

FIG. 2 is a front view of the preferred integrated cell separators illustrated in FIG. 1.

FIG. 3 is a front view of a first alternative embodiment of the integrated cell separator in accordance with the present invention shown with a cylindrical cell.

FIG. 4 is a top view of the preferred integrated cell separator illustrated in FIG. 3.

FIG. 5 is a front view of the preferred integrated cell separators illustrated in FIGS. 3-4 shown with cylindrical cells in different degrees of installation.

FIG. 6 is a front perspective view of the preferred integrated cell separators illustrated in FIGS. 3-5 shown in a box assembly.

FIG. 7 is an exploded front view of a second alternative embodiment of the integrated cell separators in accordance with the present invention shown with a pouch cell.

FIG. 8 is a front view of the preferred integrated cell separators illustrated in FIG. 7.

FIG. 9 is an exploded view of the preferred integrated cell separators illustrated in FIGS. 7-8.

FIG. 10 is an exploded front view of a third alternative embodiment of the integrated cell separators in accordance with the present invention shown with a plurality of pouch cells.

FIG. 11 is a front view of the preferred integrated cell separators illustrated in FIG. 10.

FIG. 12 is a front perspective view of the preferred integrated cell separators illustrated in FIGS. 10-11.

FIG. 13 is an exploded front view of a fourth alternative embodiment of the integrated cell separators in accordance with the present invention shown with a plurality of pouch cells.

FIG. 14 is a front view of the preferred integrated cell separators illustrated in FIG. 13.

FIG. 15 is an exploded front perspective view of the preferred integrated cell separators illustrated in FIGS. 13-14.

FIG. 16 is a schematic front view of an exemplary assembly unit adapted to produce the preferred embodiments of the integrated cell separators in accordance with the present invention.

### DESCRIPTION OF THE PREFERRED EMBODIMENTS OF THE INVENTION

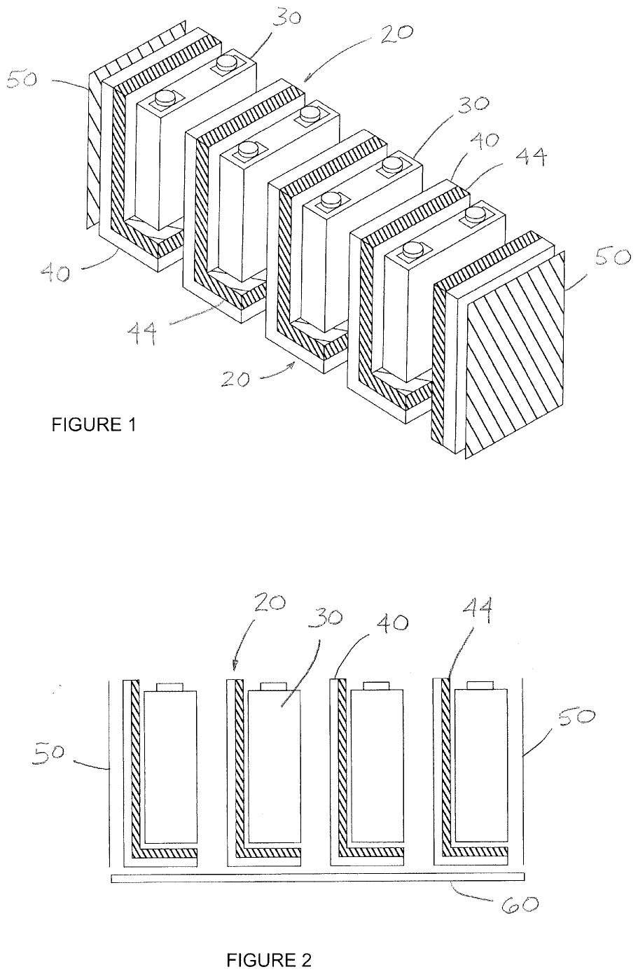

Referring now to the drawings, the preferred embodiments of the integrated cell separator in accordance with the present invention are illustrated by FIGS. 1 through 16. Referring to FIG. 1, a front perspective view of the preferred embodiment of the cell separators in accordance with the present invention shown with a plurality of prismatic cells is illustrated. As shown in FIG. 1, the preferred integrated cell separators are designated generally by reference numerals 20 and the plurality of prismatic cells are designated generally by reference numerals 30. Preferred prismatic cells 30 comprise lithium-ion batteries. Preferred integrated cell separators 20 comprises thermal isolation/flame-resistant layer 40 and compliant layer 44. Preferably, thermal isolation/flame-resistant layer 40 comprises a material having thermal isolation/flame-resistant characteristics such as Nomex®, Kevlar®, Twaron®, and other aramid fiber materials, combinations thereof, and the like. Further, preferred thermal isolation/flame-resistant layer 40 is electrically-insulating.

Still referring to FIG. 1, preferred compliant layer 44 is electrically-insulating and thermally-conductive. Preferred compliant layer 44 comprises silicon or any similarly dense, porous, thermally-stable material which retains its structural properties over a wide range of temperatures. Each preferred compliant layer 44 is adjacent to a preferred thermal isolation/flame resistant layer 40 and is adapted to contact one of the plurality of prismatic cells 30. More particularly, in the preferred embodiments of integrated cell separators 20, thermal isolation/flame-resistant layer 40 and 44 compliant layer are adhered to each other to produce each of the integrated cell separators. Preferably, integrated cell separators 20 have a finished thickness of less than approximately 2 mm. In addition, the preferred embodiments of integrated cell separators 20 are adapted to achieve thermal runaway isolation of the one or more battery cells 30, produce a slight, uniform pressure on the electrodes of the one or more battery cells (e.g., less than approximately 0.2 MPa), and provide improved thermal distribution. More particularly, preferred integrated cell separators 20 facilitate the removal of heat from the one or more battery cells 30 to the surrounding environment such as a battery enclosure or frame. The preferred integrated cell separators 20 are also adapted to electrically isolate the one or more battery cells 30 from a battery enclosure or frame. Further, preferred integrated cell separators 20 permit gases to flow through the separators, prevent liquids from flowing therethrough, dissipate pressure in the area of the one or more battery cells 30, and provides thermal runaway isolation at both the cell level and the module level.

Still referring to FIG. 1, the plurality of preferred integrated cell separators 20 and cells 30 are disposed between end plates 50. While FIG. 1 illustrates the preferred configuration and arrangement of the integrated cell separators of the invention, it is contemplated within the scope of the invention that the integrated cell separators may be of any suitable configuration and arrangement. Similarly, while FIG. 1 illustrates a plurality of prismatic battery cells, it is contemplated within the scope of the invention that the one or more battery cells may be of any suitable configuration and arrangement.

Referring now to FIG. 2, a front view of preferred integrated cell separators 20 is illustrated. As shown in FIG. 2, preferred cell separators 20 are adapted for use in connection with prismatic cells 30 and comprise thermal isolation/flame-resistant layer 40 and compliant layer 44. As also shown in FIG. 2, preferred integrated cell separators 20 are disposed between end plates 50 and above base plate 60.

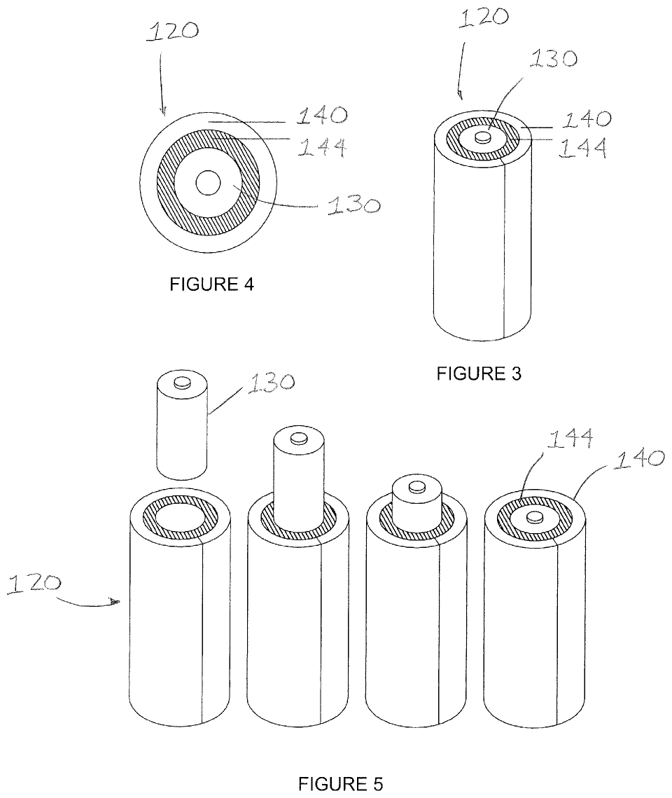

Referring now to FIG. 3, a front view of a first alternative embodiment of the integrated cell separator shown with a cylindrical cell is illustrated. As shown in FIG. 30, the preferred integrated cell separator is designated generally by reference numeral 120 and the cylindrical cell is designated generally by reference numeral 130. Preferred integrated cell separator 120 comprises thermal isolation/flame-resistant layer 140 and compliant layer 144.

Referring now to FIG. 4, a top view of preferred cell separator 120 is illustrated. As shown in FIG. 4, preferred integrated cell separator 120 comprises thermal isolation/flame-resistant layer 140 and compliant layer 144.

Referring now to FIG. 5, a front view of preferred cell separators 120 shown with cylindrical cells 130 in different degrees of installation is illustrated. As shown in FIG. 5, preferred integrated cell separator 120 comprises thermal isolation/flame-resistant layer 140 and compliant layer 144.

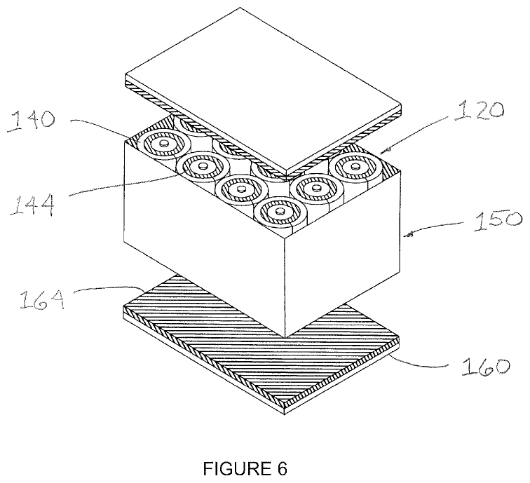

Referring now to FIG. 6, a front perspective view of preferred cell separators 120 shown in a box assembly 150 is illustrated. As shown in FIG. 6, preferred cell separators 120 comprise thermal isolation/flame-resistant layer 140 and compliant layer 144. As also shown in FIG. 6, preferred box assembly 150 comprises box assembly thermal isolation/flame-resistant layer 160 and box assembly compliant layer 164.

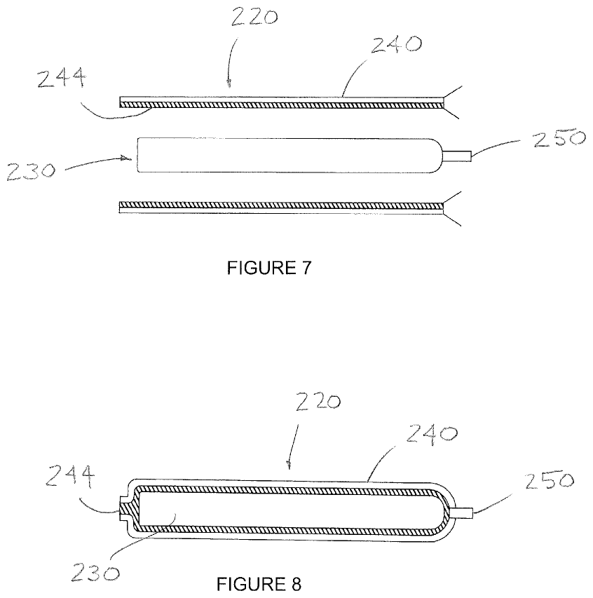

Referring now to FIG. 7, an exploded front view of a second alternative embodiment of the integrated cell separators shown with a pouch cell is illustrated. As shown in FIG. 7, preferred integrated cell separators are designated generally by reference numeral 220 and the pouch cell is designated generally by reference numeral 230. Preferred integrated cell separators 220 comprise thermal isolation/flame-resistant layer 240 and compliant layer 244, and preferred pouch cell 230 comprises one or more tabs 250.

Referring now to FIG. 8, a front view of preferred cell separators 220 is illustrated. As shown in FIG. 8, preferred cell separators 220 comprise thermal isolation/flame-resistant layer 240 and compliant layer 244, and preferred pouch cell 230 comprises tab 250.

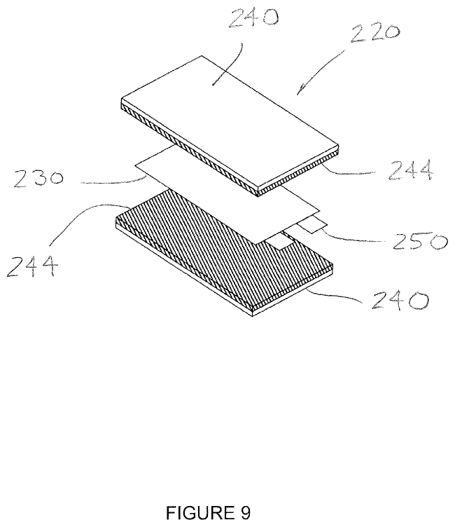

Referring now to FIG. 9, an exploded perspective view of preferred cell separators 220 is illustrated. As shown in FIG. 9, preferred cell separators 220 comprise thermal isolation/flame-resistant layer 240 and compliant layer 244, and preferred pouch cell 230 comprises tabs 250.

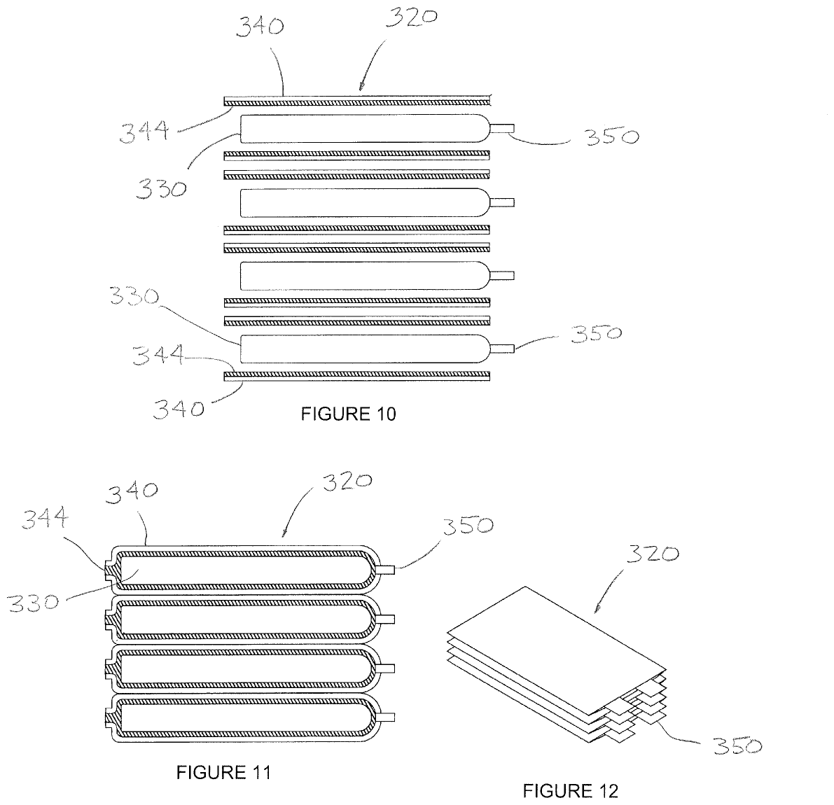

Referring now to FIG. 10, an exploded front view of a third alternative embodiment of the cell separators shown with a plurality of pouch cells is illustrated. As shown in FIG. 10, the preferred cell separators are designated generally by reference numerals 320 and the preferred pouch cells are designated generally by reference numerals 330. Preferred integrated cell separators 320 comprise thermal isolation/flame-resistant layer 340 and compliant layer 344, and preferred pouch cells 330 comprise tabs 350.

Referring now to FIG. 11, a front view of preferred cell separators 320 is illustrated. As shown in FIG. 11, preferred integrated cell separators 320 comprise thermal isolation/flame-resistant layer 340 and compliant layer 344, and preferred pouch cells 330 comprise tabs 350.

Referring now to FIG. 12, a front perspective view of preferred integrated cell separators 320 is illustrated. As shown in FIG. 12, a pair of preferred integrated cell separators 320 substantially encloses each individual pouch cell except for a portion of tabs 350.

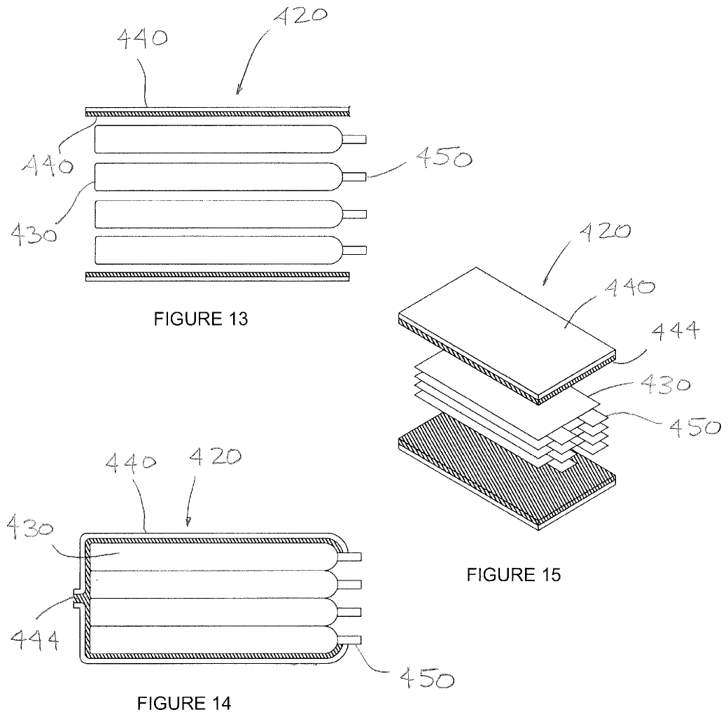

Referring now to FIG. 13, an exploded front view of a fourth alternative embodiment of the integrated cell separators shown with a plurality of pouch cells is illustrated. As shown in FIG. 13, the preferred integrated cell separators are designated generally by reference numerals 420 and the pouch cells are designated generally by reference numerals 430. Preferred integrated cell separators comprise thermal isolation/flame-resistant layer 440 and compliant layer 444, and preferred pouch cells 430 comprise tabs 450.

Referring now to FIG. 14, a front view of preferred integrated cell separators 420 is illustrated. As shown in FIG. 14, preferred integrated cell separators 420 comprise thermal isolation/flame-resistant layer 440 and compliant layer 444, and preferred pouch cells 430 comprise tabs 450.

Referring now to FIG. 15, an exploded front perspective view of the preferred integrated cell separators 420 is illustrated. As shown in FIG. 15, preferred integrated cell separators 420 comprise thermal isolation/flame-resistant layer 440 and compliant layer 444, and preferred pouch cells 430 comprise tabs 450.

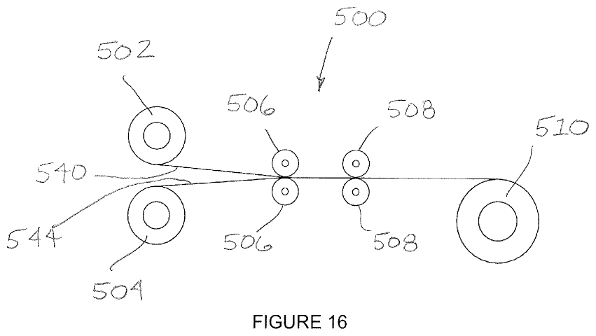

Referring now to FIG. 16, a schematic front view of an exemplary assembly unit adapted to produce the preferred embodiments of the integrated cell separators is illustrated. As shown in FIG. 16, the exemplary assembly unit is designated generally by reference numeral 500. Preferably, exemplary assembly unit 500 comprises thermal isolation/flame-resistant layer roll 502, compliant layer roll 504, a pair of lamination rollers 506, a pair of compression rollers 508, and a finished product roll 510. According to the preferred embodiments of the manufacturing process of the invention, thermal isolation/flame-resistant layer 540 from thermal isolation/flame-resistant layer roll 502 and compliant layer 544 from compliant layer roll 504 are initially fed between lamination rollers 506. Next, thermal isolation/flame-resistant layer 540 and compliant layer 544 are fed between compression rollers 508. Thereafter, preferred thermal isolation/flame-resistant layer 540 and preferred compliant layer 544 are fed onto finished product roll 510.

While FIG. 16 illustrates the preferred apparatus and method for manufacturing the integrated cell separators, it is contemplated within the scope of the invention that any suitable apparatus and method may be employed to produce the integrated cell separators. More particularly, while the preferred layers of the integrated cell separators are combined via lamination, it is contemplated within the scope of the invention that the layers of the preferred integrated cell separators may be combined by any suitable means including, but not limited to, direct flame lamination, chemical reaction lamination, adhesive film, or direct application processes depending upon the desired thickness and porosity ratios.

In operation, several advantages of the preferred embodiments of the integrated cell separators of the invention are achieved. For example, the preferred embodiments of the integrated cell separators improve the mechanical stability of one or more battery cells and limit the negative effects of vibration. The preferred embodiments of the integrated cell separators also aid with cell impedance over time and heat transfer between the one or more battery cells and the enclosure or frame of a battery assembly. Further, the electrically-insulating nature of the preferred integrated cell separators permits isolation between the one or more battery cells and the enclosure or frame of the battery assembly and aids in passive thermal management by transferring heat either away from the battery cells to the enclosure or by transferring heat from the enclosure to the battery cells for pre-charge or discharge warming processes. Still further, the preferred integrated cell separators provide improved cycle life and mechanical system reliability. In addition, the preferred integrated cell separators provide flame propagation mitigation while also allowing built-up gas pressure to be released. The preferred integrated cell separators are also semi-permeable, thereby allowing heat and gasses to pass through them while preventing larger molecules such as liquids from passing through them. The preferred integrated cell separators also protect against impact forces which is particularly advantageous in pouch cell assemblies and constructions lacking a rigid outer frame, casing, or enclosure.

In addition, through testing and empirical data collection, the preferred embodiments of the integrated cell separator demonstrate a significant improvement over conventional products in terms of preventing cell to cell flame propagation while at the same time controlling the event in such a way that surrounding secondary ignition sources remain inert or unaffected. More particularly, following an initial materials study, trial candidates were procured and a testing protocol was developed to compare and contrast single and multilayer materials, both in resilience against direct flame, replicating that of a catastrophic battery failure, as well as the materials' ability to prevent transmission of a flame to an immediately adjacent secondary ignition source. All materials were tested with application of direct flame originating from a propane fueled burner outputting an approximately 1000° Celsius flame.

After identifying a silicone compliant material which performed to a 400° Celsius smoke point, trials continued with various laminations of silicone compliant material and flame retardant fabrics. Extensive testing demonstrated that the laminations of the preferred integrated cell separator significantly delayed passage of a flame through the separator to a secondary ignition source while also holding the silicone compliant material together in a way which greatly increased its effectiveness in dispersing heat over a greater surface area and limiting flame passage. While the silicone compliant materials alone would break down and allow passage of flame within a matter of seconds, with the laminations of the preferred integrated cell separator were able to achieve upwards of seven (7) minutes of direct flame before ignition of the immediately adjacent secondary ignition source.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. An integrated cell separator adapted for use with one or more battery cells, said integrated cell separator comprising:
(a) a thermal isolation/flame-resistant layer;
(b) a compliant layer, said compliant layer being adjacent to said thermal/isolation/flame resistant layer;
wherein the thermal isolation/flame-resistant layer and the compliant layer are adhered to each other to produce the integrated cell separator; and wherein the compliant layer is adapted to contact the one or more battery cells; and wherein the separator is adapted to provide thermal runaway isolation of the one or more battery cells.

2. The integrated cell separator of claim 1 wherein the separator is laminated.

3. The integrated cell separator of claim 1 wherein the separator has a finished thickness of less than approximately 2 mm.

4. The integrated cell separator of claim 1 wherein the thermal isolation/flame-resistant layer comprises aramid.

5. The integrated cell separator of claim 1 wherein the thermal isolation/flame-resistant layer is electrically-insulating.

6. The integrated cell separator of claim 1 wherein the compliant layer comprises silicon.

7. The integrated cell separator of claim 1 wherein the compliant layer is electrically-insulating.

8. The integrated cell separator of claim 1 wherein the compliant layer is thermally-conductive.

9. The integrated cell separator of claim 1 wherein the one or more battery cells are lithium-ion cells.

10. The integrated cell separator of claim 1 wherein the separator produces uniform electrode pressure.

11. The integrated cell separator of claim 1 wherein the separator provides improved thermal distribution.

12. The integrated cell separator of claim 1 wherein the separator provides improved removal of heat from the one or more battery cells to the surrounding environment.

13. The integrated cell separator of claim 1 wherein the separator permits gases to flow through the separator.

14. The integrated cell separator of claim 1 wherein the separator provides thermal runaway isolation at a cell level.

15. The integrated cell separator of claim 1 wherein the separator provides thermal runaway isolation at a module level.

16. The integrated cell separator of claim 1 wherein the separator provides pressure dissipation.

17. The integrated cell separator of claim 1 wherein the separator prevents liquid from passing through the separator.

18. The integrated cell separator of claim 1 wherein the separator is adapted for use with one or more pouch cell/cell-to-pack arrangements.

19. The integrated cell separator of claim 1 wherein the separator electrically isolates the one or more battery cells from an enclosure.

20. A method for separating one or more battery cells, said method comprising:
(a) providing an integrated cell separator, said integrated cell separator comprising:
(i) a thermal isolation/flame-resistant layer;
(ii) a compliant layer, said compliant layer being adjacent to said thermal/isolation/flame resistant layer;
wherein the thermal isolation/flame-resistant layer and the compliant layer are adhered to each other to produce the integrated cell separator; and wherein the compliant layer is adapted to contact the one or more battery cells; and wherein the separator is adapted to provide thermal runaway isolation of the one or more battery cells; and
(b) separating the one or more battery cells using the integrated cell separator.
